(19) United States
(12) Patent Application Publication
(10) Pub. No.: US 2015/0338861 A1
(43) Pub. Date: Nov. 26, 2015

(54) TAP CHANGER

(71) Applicant: MASCHINENFABRIK REINHAUSEN GMBH, Regensburg (DE)

(72) Inventor: Andrey GAVRILOV, Regensburg (DE)

(21) Appl. No.: 14/761,372

(22) PCT Filed: Jan. 15, 2014
(86) PCT No.: PCT/EP2014/050697

§ 371 Date: Jul. 16, 2015

(30) Foreign Application Priority Data
Feb. 20, 2013 (DE) 10 2013 101 652.9

(51) Int. Cl. G05F 1/20

(52) U.S. Cl. CPC G05F 1/20

(57) ABSTRACT

The invention relates to an on-load tap changer (1) for controlling voltage, comprising semiconductor switching elements (61, 62, 71, 72), and to a method for controlling voltage for a variable transformer (2). The on-load tap changer (1) has a first load branch (6) and a second load branch (7) arranged parallel thereto. A partial winding (8) is arranged between the first and second load branches (6, 7). In the first load branch (6), a first semiconductor switching element (61) is provided upstream of the partial winding (8) and a second semiconductor switching element (62) is provided downstream of the partial winding (8). In the second load branch (7), a first semiconductor switching element (71) is provided upstream of the partial winding (8) and a second semiconductor switching element (72) is provided downstream of the partial winding (8). The on-load tap changer (1) consists of at least one switching module (5), which comprises the first load branch (6) and the second load branch (7) of the on-load tap changer.

The invention relates to an on-load tap changer with semiconductor switches. In particular, the on-load tap changer consists of a plurality of switching modules and is connected with a control winding.

In addition, the invention relates to a method of operating an on-load tap changer.

A tap changer for voltage regulation with semiconductor switching units is known from DE 10 2011 012 080 A1. The tap changer has two parallel load branches, wherein semiconductor switching units are connected in series in both load branches. In that case, a respective semiconductor switching unit of the first load branch and of the second load branch are mutually opposite in pairs. A respective sub-winding and bridge are connected, in alternation between these paired semiconductor switching units, switch between the two load branches. The sub-windings have different winding counts. The semiconductor switching units can be constructed as thyristor pairs or IGBT pairs. The windings can be switched on and off by adept switching of the semiconductor switching units. The translation ratio from the transformer can thereby be adapted and the voltage at the secondary side thus regulated. It is also possible, through use of IGBTs, to realize with the help of pulse-width modulation an alternating switching on and switching off of a sub-winding and to thereby implement a finely-stepped voltage regulator. Switching losses arise due to constant switching-on and switching-off of the semiconductor switching units and the semiconductor switching units heat up, that imposes a high level of demand on the cooling device.

The object of the invention is to provide an on-load tap changer for voltage regulation with semiconductor switches, that has lower switching losses, requires a smaller cooling device and is thus more economic and reliable.

This object is fulfilled by an on-load tap changer according to the invention for voltage regulation in accordance with claim 1. In that case, the subclaims relate to advantageous developments of the invention.

The object of the invention is additionally to provide a method of operating an on-load tap changer with semiconductor switching units in which lower switching losses arise, heat output is reduced and reliability is increased.

This object is fulfilled by a method according to the invention for operating an on-load tap changer for voltage regulation in accordance with claim 5. In that case, the subclaims relate to advantageous developments of the method.

The general inventive idea consists of using two IGBTs, which are connected anti-serially, with inverse diodes as semiconductor switching units and in the case of pulse-width modulation to take into account the direction of the current and orientation of the voltage at the sub-winding so as to then not switch off a part of the load branch and to thus avoid switching losses.

According to the preferred form of embodiment of the invention the on-load tap changer for voltage regulation comprises semiconductor switches and is arranged at a control transformer with control windings. This is arranged between a fixed unregulated part of the control winding and a load diverter. Moreover, the on-load tap changer has a first load branch and a second load branch arranged parallel thereto, wherein a sub-winding is arranged between the load branches. The first load branch has a first semiconductor switch in front of the sub-winding and a second semiconductor switch downstream of the sub-winding. The second load branch similarly has a first semiconductor switch in front of the sub-winding and a second semiconductor switch downstream of the sub-winding. The on-load tap changer comprises at least one switching module that comprises the first load branch and the second load branch.

According to a further form of embodiment of the invention each semiconductor switch consists of a respective first IGBT and second IGBT that are connected anti-serially with respect to one another. The IGBTs are each provided with a respective inverse diode in such a way that an anode of one inverse diode is connected with an emitter terminal and a cathode of the inverse diode is connected with a connector terminal of the first IGBT and of the second IGBT. The semiconductor switches of the first load branch and the second load branch can in that case be selectably switched off.

According to another form of embodiment the on-load tap changer consists of a first switching module, a second switching module and a third switching module. In that case, the sub-windings of the switching modules respectively have different winding ratios from one another, for example 9:3:1.

In the method according to the invention for operation of the on-load tap changer it is initially determined between which settings a sub-winding of a switching module shall be changed. In the case of a reducing setting windings of the sub-winding are subtracted from a control winding, in the case of an increasing setting windings of the sub-winding are added to the control winding and in the case of a nominal setting the sub-winding is left out completely.

A further step according to the method in accordance with the invention relates to determination of an active side and a passive side of the switching module. The semiconductor switches are actuated on the active side of the switching module, whilst these are shifted into a fixed switching setting on the opposite side.

After determination of the direction of a current and the orientation of a voltage at the sub-winding the switching states of the semiconductor switches of the switching module are defined. In that case, the IGBTs that are connected to the alternatingly current-conducting inverse diodes of the respective active side, of the first semiconductor switches or second semiconductor switches are constantly blocking. Of the two alternately current-conducting IGBTs of the active side one is always conducting and, in particular, that IGBT whose collector terminal is connected with a negative pole and the emitter terminal is connected with a positive pole of the sub-winding. Of the two alternately current-conducting IGBTs of the active side one is cycled and, in particular, that at which the collector terminal is connected with the positive pole and the emitter terminal with the negative pole of the sub-winding. At the passive side, one semiconductor switch is constantly blocked and the other semiconductor switch is constantly conducting.

In the case of change of the direction of the current flow and orientation of the positive pole and the negative pole at the sub-winding it is ascertained which IGBTs of the semiconductor switches on the active side are switched to be cycled or conducting and on the passive side are switched to be conducting or non-conducting, and generally which of the sides is active or passive.

These and other features and advantages of the form of embodiment disclosed here will be better understood by reference to the following description and the drawings, in which the same reference numerals throughout denote the same elements and in which:

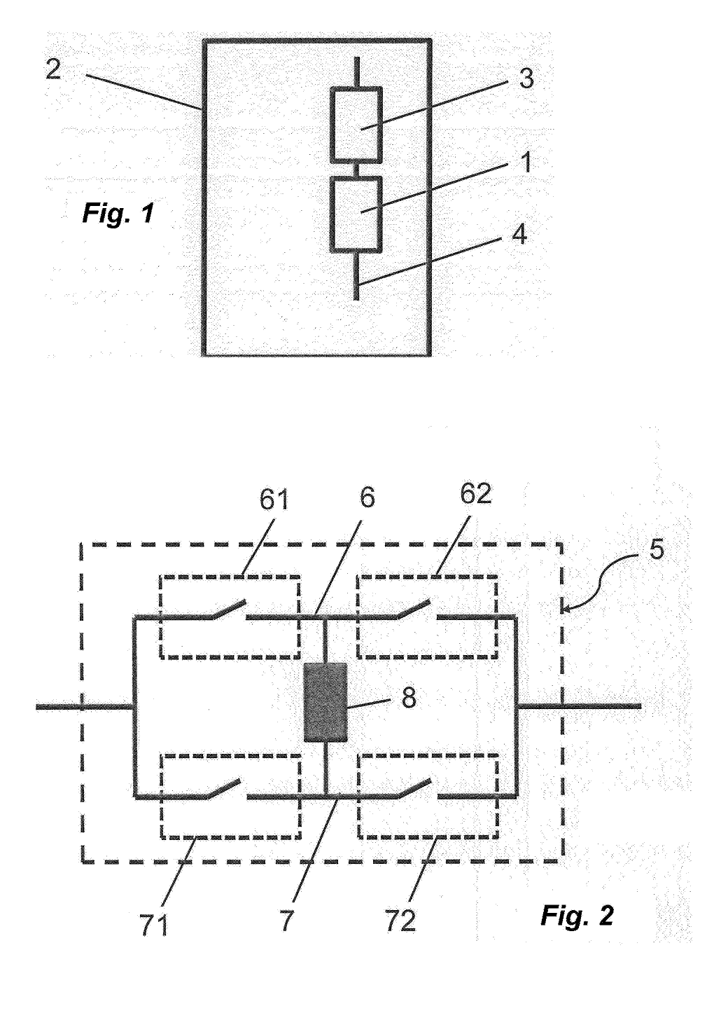

FIG. 1 shows a schematic illustration of a tap changer in conjunction with a transformer;

FIG. 2 shows a schematic illustration of the tap changer with semiconductor switches;

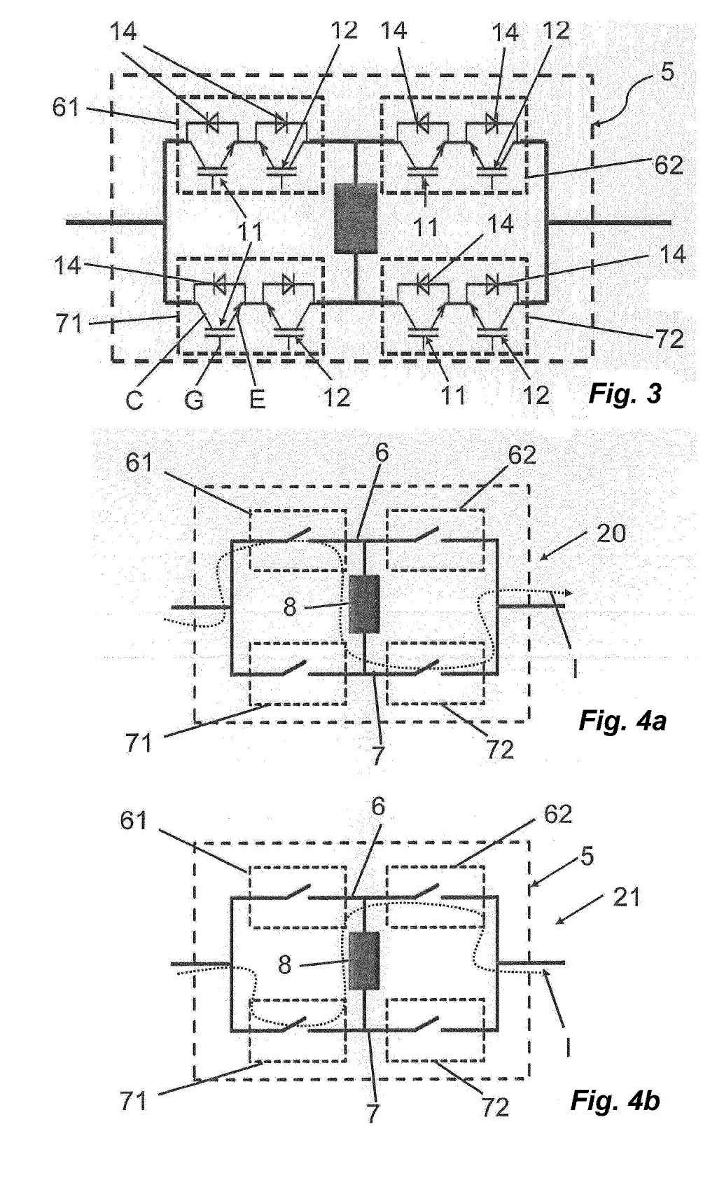

FIG. 3 shows an illustration of the electronic construction of the semiconductor switches;

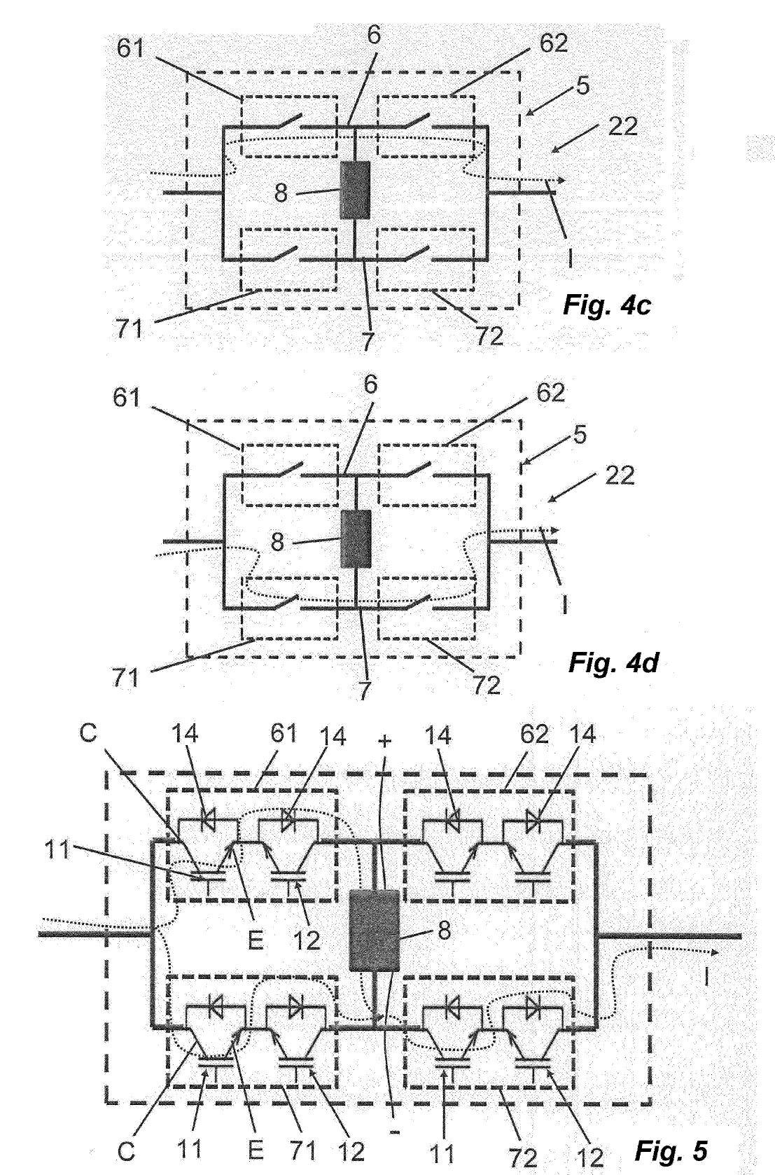

FIGS. 4a-4d show illustrations of the different switching settings of the on-load tap changer;

FIG. 5 shows an illustration of the semiconductor switches in a switching setting;

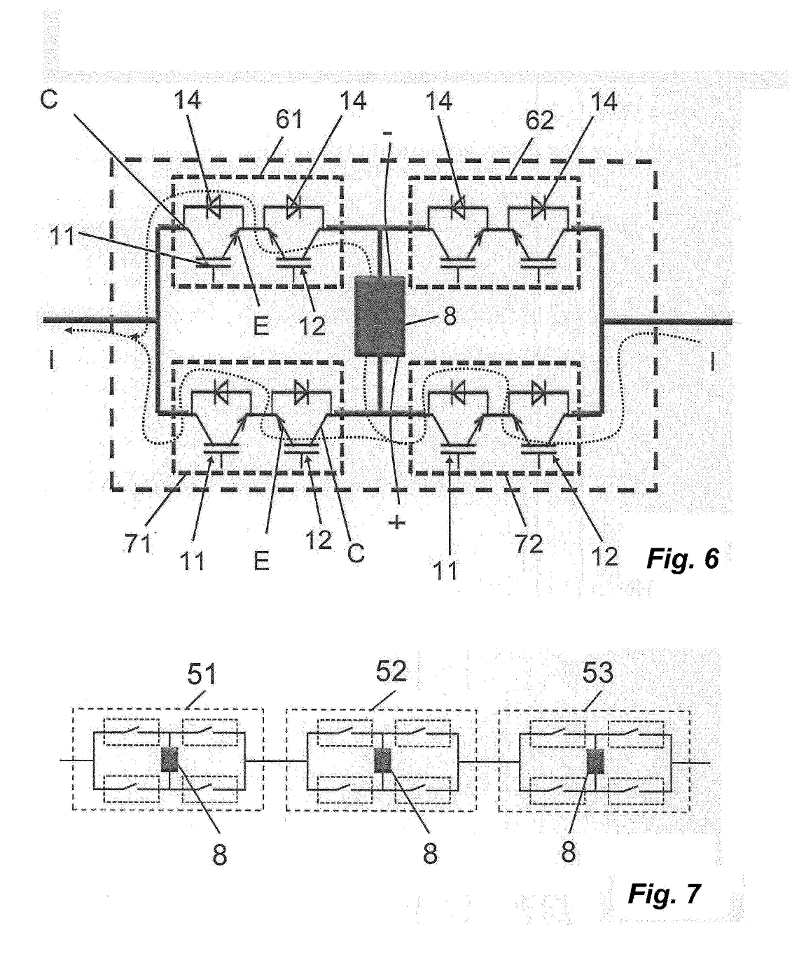

FIG. 6 shows a further illustration of a switching setting of the semiconductor switch; and

FIG. 7 shows a schematic illustration of the connection of three switching modules.

Identical reference numerals are used for the same or equivalent elements of the invention. The illustrated embodiment represents merely one possibility of how the switch according to the invention can be realized.

An on-load tap changer 1 for voltage regulation in a control transformer 2 and a control winding 3 is illustrated in FIG. 1. The on-load tap changer 1 is arranged between the fixed, unregulated part of the control winding 3 and a load diverter 4.

As illustrated in FIG. 2, the on-load tap changer 1 consists of at least one switching module 5. The switching module 5 has a first load branch 6 and a second load branch 7 arranged parallel thereto. The first and second load branches 6 and 7 of the switching module 5 are conductively connected together by way of a sub-winding 8. The first load branch 6 has a first semiconductor switch 61 between the control winding 3 and the sub-winding 8 and a second semiconductor switch 62 downstream of the sub-winding 8, thus toward the load diverter 4. The second load branch 7 similarly has a first semiconductor switch 71 in front of the sub-winding 8 and a second semiconductor switch 72 downstream of the sub-winding 8.

In FIG. 3 it is illustrated that each of the semiconductor switches 61, 62, 71 and 72 consists of a first Insulated Gate Bipolar Transistor (IGBT) 11 and a second IGBT 12 that are connected anti-serially. The first IGBT 11 and the second IGBT 12 are each provided with a respective inverse diode 14. Each IGBT 11 and 12 has a collector terminal C, an emitter terminal E and a gate terminal G. Each of the inverse diodes 14 is connected by the anode thereof with the emitter terminal E and by the cathode thereof with the collector terminal C of the respective IGBT 11 or 12.

As illustrated in FIGS. 4a-4d, it is initially determined which of the settings the sub-winding 8 adopts. In a reducing setting 20 (FIG. 4a) the windings of the sub-winding 8 are subtracted from the fixed part of the control winding 3. In that case, the current I flows in direction-independent manner through the first semiconductor switch 61 in the first load branch 6, the sub-winding 8 and the second semiconductor switch 72 in the second load branch 7.

In an increasing setting 21 (FIG. 4b) the windings of the sub-winding 8 are added to the fixed part of the control winding 3. In that case, the current I flows in direction-independent manner through the first semiconductor switch 71 in the second load branch 7, the sub-winding 8 and the second semiconductor switch 52 in the first load branch 6.

In a nominal setting 22 (FIGS. 4c and 4d) the current I is selectively conducted past the sub-winding 8 by way of either the first load branch 6 or the second load branch 7. In this setting the windings of the sub-winding 8 have no influence on the control winding 3.

In order to be able to implement a finely stepped regulation and produce an intermediate step there is cycling between two of the three explained settings by pulse-width modulation. If there is switching between the nominal setting 22 and the reducing setting 20 or increasing setting 21, a passive side and an active side of the switching module 5 has to be ascertained; this is the regulation case. Always belonging to a respective side are the semiconductor switches 61 and 71 or 62 and 72, respectively that lie on the same side, thus upstream of or downstream of the sub-winding 8. It thus has to be ascertained whether the first semiconductor switch 61 of the first load branch 6 and the first semiconductor switch 71 of the second load branch 7 are active and the second semiconductor switch 62 of the first load branch 6 and the second semiconductor switch 72 of the second load branch 7 are passive, or conversely. Depending on this determination, the IGBTs 11 and 12 of the semiconductor switches 61, 62, 71 and 72 have to be differently switched. The semiconductor switches on the ascertained passive side are always kept conducting or blocking during the procedure, wherein one semiconductor switch is conducting and the other is non-conducting. On the active side, the semiconductor switches are, due to the pulse-width modulation carried out, switched to be active, i.e. these adopt different states. In the case of switching between reducing setting 20 and increasing setting 21, both sides are active.

In the example of FIG. 5 the active side of the illustrated switching module 5 consists of the first semiconductor switch 61 of the first load branch 6 and the first semiconductor switches 71 of the second load branch 7. Consequently, the passive side of FIG. 5 consists of the second semiconductor switch 62 of the first load branch 6 and the second semiconductor switch 72 of the second load branch 7.

On the passive side, the second semiconductor switch 72 of the second load branch 7 is always conducting. The second semiconductor switch 62 of the load branch 6 is, on the other hand, always non-conducting. The current I thus flows either through the first IGBT 11 and the inverse diode 14 that is connected with the second IGBT 12, or in opposite direction through the second IGBT 12 and the inverse diode 14 that is connected with the first IGBT 11. The first and second IGBTs 11 and 12 of the second semiconductor switch 62 in the first load branch 6 are, thereagainst, always blocking so that no current I flows here.

On the active side, the first or second IGBTs 11 or 12 of the first semiconductor switches 61 and 71, whose pass direction does not correspond with the current flow direction, are blocked. In that case, the current I flows via the inverse diodes 14 connected in parallel therewith. Of the remaining two IGBTs 11 or 12 of the first semiconductor switches 61 and 71 one is always conducting and, in particular, that IGBT whose collector terminal C is connected with a negative pole ‘−’ and the emitter terminal E with a positive pole ‘+’ of the sub-winding 8, possibly by way of other IGBTs or inverse diodes. Finally, the fourth IGBT of the active side is cycled at a duty cycle corresponding with the intermediate step to be achieved. The collector terminal C of this IGBT thus lies at the positive pole ‘+’ and the emitter terminal E at the negative pole ‘−’.

The anti-serial IGBT, which is opposite the cycled IGBT, of the respective semiconductor switch is switched on shortly ahead of the current zero transition so as to ensure a secure current path during the current direction change.

In the example in FIG. 5, the orientation of the voltage U is such that the positive pole ‘+’ lies at the upper side of the sub-winding 8 and the negative pole ‘−’ lies at the lower side. Since the current I flows from left to right, use is made for that purpose of the first IGBTs 11 of the first semiconductor switches 61 and 71 and the inverse diodes 14 that are connected in parallel with the second IGBT 12 of the first semiconductor switches 61 and 71. With consideration of the first IGBTs 11 of the first semiconductor switches 61 and 71, then the positive pole ‘+’ of the sub-winding 8 lies at the collector terminal C of the first IGBT 11 of the first semiconductor switch 71 in the second load branch 7 and the negative pole ‘−’ of the sub-winding 8 lies at the emitter terminal E. This is thus cycled, whereas the first IGBT 11 of the first semiconductor switch 61 and the first load branch 6 is permanently conducting. The second IGBT 12 of the first semiconductor switch 71 in the second load branch 7 is switched to be conducting shortly ahead of the current zero transition, thus in advance of the direction change of the current I.

After each voltage or current direction change it is always newly defined which IBGTs are conductive that are blocking and which are cycled. In that case, a change of the active side and passive side can serve for uniform distribution of the losses and thus lead to lengthening of the service life of the components.

In the case of pure ohmic loads of the on-load tap changer 1 the direction of the current I and the orientation of the voltage U at the sub-winding 8 change at the same time. In the case of inductive and capacitive loads, the orientation of the voltage U changes with an offset relative to the directional change of the current I.

The switching module 5 of FIG. 5 is illustrated in FIG. 6. The lefthand side of the switching module 5 with the semiconductor switches 61 and 71 is, as previously determined, still always active and the right-hand side of the switching module 5 with the semiconductor switches 62 and 72 is passive. Here, the direction of the current I has changed, so that this flows from the right-hand side to the lefthand side of the switching module 5. Starting from an ohmic load, the orientation of the voltage U at the sub-winding 8 has similarly also reversed. The negative pole ‘−’ now lies at the upper end of the sub-winding 8 and the positive pole ‘+’ now lies at the lower end of the sub-winding 8.

On the passive side, the current I is conducted by way of the second semiconductor switch 72 in the second load branch 7, particularly the second IGBT 12 of the second semiconductor switch 72 and the inverse diode 14 that is connected in parallel with the first IGBT 11 of the second semiconductor switch 72. The second semiconductor switch 62 in the first load branch is in that case always non-conducting. On the active side of the switching module 5 the current I can flow only by way of the inverse diodes 14 that are connected in parallel with the first IGBTs 11 of the first and second semiconductor switches 61 and 71, as well as the second IGBTs 12 of the first and second semiconductor switches 61 and 71. In that case, the positive pole ‘+’ lies at the collector terminal C of the second IGBT 12 of the first semiconductor switch 71 in the second load branch 7; this is thus cycled. Since the second IGBT 12 of the first semiconductor switch 71 in the second load branch 7 is cycled, the second IGBT 12 of the first semiconductor switch 61 in the load branch 6 is consequently switched to be permanently conducting.

Due to the fact that during the method one semiconductor switch 61, 61, 71 or 72 on the active side is always permanently conducting, i.e. at low-impedance, switching losses arising in the prior art on transition from the high-impedance state to the low-impedance state are significantly reduced. Heat output at the switching module 5 thereby diminishes, so that less thermal energy has to be dissipated by the cooling. In general, in the case of use of this method a physically smaller and thus less expensive cooling plant can be employed.

An on-load tap changer 1 is depicted in FIG. 7, in which a first switching module 51, a second switching module 52 and a third switching module 53 are connected in series. The sub-windings 8 of these switching modules 51, 52 and 53 have different winding ratios. Distribution of the winding ratios in 9:3:1 is particularly advantageous. Through use of the method according to the invention in one of these switching modules 51, 52 or 53 it is possible to combine the finer intermediate steps, which are produced here, with the steps of the other switching modules 51, 52 and 53.

1. An on-load tap changer for voltage regulator, the tap changer comprising:
a control transformer with a control winding;
semiconductor switches at the control transformer;
a fixed unregulated part of the control winding and a load diverter flanking the on-load tap changer;
a first load branch and a second load branch parallel thereto;
a sub-winding between the first load branch and the second load brand;
a first semiconductor switch upstream of the sub-winding in the first load branch and a second semiconductor switch downstream of the sub-winding; and
a first semiconductor switch upstream of the sub-winding in the second load branch and a second semiconductor switch downstream of the sub-winding; and
at least one switching module that comprises the first load branch and the second load branch of the on-load tap changer.

2. The on-load tap changer according to claim 1, wherein
each semiconductor switch consists of a respective first IGBT and second IGBT that are connected anti-serially with respect to one another,
the first IGBT and the second IGBT are each provided with an inverse diode in such a way that an anode of one inverse diode is connected with an emitter terminal and a cathode of an inverse diode is connected with a collector terminal of the first IGBT and the second IGBT and
the semiconductor switches of the first load branch and the second load branch are selectably switchable off.

3. The on-load tap changer according to claim 1, wherein the on-load tap changer consists of a first switching module, a second switching module and a third switching module and the sub-windings of the switching modules have different winding ratios with respect to one another.

4. The on-load tap changer according to claim 3, wherein a winding ratio of the sub-windings is 9:3:1.

5. A method of operating an on-load tap changer having a switching module in turn having a sub-winding, an active side, a passive side, and semiconductor switches, the method comprising the following steps:
determining the settings that are to be changed of the sub-winding of the switching module,
determining the active side and the passive side of the switching module,
determining a direction of a current and an orientation of a voltage at the sub-winding, and
determining switching states of semiconductor switches of the switching module.

6. The method according to claim 5, further comprising the steps of:
in the case of a reducing setting, windings of the sub-winding are subtracted from a control winding,
in the case of an increasing setting, windings of the sub-winding are added to the control winding, and
in the case of a nominal setting, the sub-winding is left out completely.

7. The method according to claim 5, wherein
the semiconductor switches or the semiconductor switches are actuated on an active side of the switching module and
the semiconductor switches or the semiconductor switches remain in a fixed switching state on the passive side of the switching module.

8. The method according to any one of claim 5, wherein
each semiconductor switch consists of a respective first IGBT and second IGBT that are connected anti-serially with respect to one another,
the first IGBT and the second IGBT are each provided with an inverse diode in such a way that an anode of one inverse diode is connected with an emitter terminal and a cathode of an inverse diode is connected with a collector terminal of the first IGBT and the second IGBT,
the IGBTs connected with the alternately current-conducting inverse diodes of the respective active side, of the first semiconductor switches or second semiconductor switches are constantly blocking,
of the two alternately current-conducting IGBTs of the active side, one is always conducting and that IGBT whose collector terminal is connected with a negative pole and the emitter terminal is connected with a positive pole of the sub-winding,
of the two alternately current-conducting IGBTs of the active side, one is cycled and that IGBT whose collector terminal is connected with the positive pole and whose emitter terminal with the negative pole of the sub-winding, and
at a passive side, one semiconductor switch is always blocked and the other semiconductor switch is always conducting.

9. The method according to any one of claim 5, wherein in the case of change in the direction of the current flow and the orientation of the positive pole and the negative pole it is detected at the sub-winding which IGBTs of the semiconductor switch on the active side are cycled or switched to be conducting.

10. The method according to claim 9, wherein in the case of change in the direction of the current flow and the orientation of the positive pole and the negative pole it is detected at the sub-winding which IGBTs of the semiconductor switch on the passive side are switched to be conducting or non-conducting.

11. The method according to claim 10, wherein in the case of change in direction of the current flow and the orientation of the positive pole and the negative pole the active side and the passive side are determined at the sub-winding.
